(19) United States
(12) Patent Application Publication
(10) Pub. No.: US 2012/0088570 A1
(43) Pub. Date: Apr. 12, 2012

(54) Processing a Marker Transaction at a Gaming Establishment

(75) Inventor: Andrew J. Schwartz, Chester Springs, PA (US)

(73) Assignee: AUTOMATED CURRENCY INSTRUMENTS, INC., West Chester, PA (US)

(21) Appl. No.: 13/267,098

(22) Filed: Oct. 6, 2011

Related U.S. Application Data
(63) Continuation-in-part of application No. 12/143,496, filed on Jun. 20, 2008.
Application No. 12/143,496 is a continuation-in-part of application No. PCT/US2011/021354, filed on Jan. 14, 2011.
(60) Provisional application No. 60/945,703, filed on Jun. 22, 2007.
(60) Provisional application No. 61/295,033, filed on Jan. 14, 2010.

(51) Int. Cl. A63F 13/00

(52) U.S. Cl. 463/25

(57) ABSTRACT

In one embodiment, a system and method for processing a marker transaction by a customer of a gaming establishment via a kiosk. The customer has a marker account prior to initiating the marker transaction at the kiosk. The kiosk is adapted to communicate with (i) a marker account system to process the transaction and (ii) a gaming media system for marker payouts in the form a gaming media, such as gaming scrips. By providing the customer with gaming scrips having no intrinsic value, the gaming establishment at most assumes a deferred risk and possibly little or no risk at all for having issued the marker to the customer.

### CROSS-REFERENCE TO RELATED APPLICATIONS

This is a continuation-in-part of co-pending application Ser. No. 12/143,496, filed on Jun. 20, 2008, which itself claims priority from provisional application No. 60/945,703, filed on Jun. 22, 2007, the teachings of both of which are incorporated herein by reference in their entirety.

This is also a continuation-in-part of co-pending PCT application no. PCT/US2011/021354 (“the parent PCT application”), filed on Jan. 14, 2011, which itself claims priority from provisional application No. 61/295,033, filed on Jan. 14, 2010, the teachings of both of which are incorporated herein by reference in their entirety.

### BACKGROUND OF THE INVENTION

1. Field of the Invention

The present invention relates to gaming establishments, such as casinos, and, more specifically but not exclusively, to marker transactions at such gaming establishments.

2. Description of the Related Art

This section introduces aspects that may help facilitate a better understanding of the invention. Accordingly, the statements of this section are to be read in this light and are not to be understood as admissions about what is prior art or what is not prior art.

A “marker” is a form of credit offered by a casino to customers of the casino. FIG. 1 shows the typical steps in obtaining and collecting on a marker. In a traditional marker transaction 10, the customer establishes a line of credit with the casino, typically by completing a credit application (step 12). The casino (or its agent) will then determine the amount of credit to be extended to the customer and the payout terms (step 14), typically by taking into account the balances in the financial accounts listed on the application, the customer's credit history, and playing history with the casino. In some cases, the casino may allow the customer to take a marker at no fee and/or provide a grace period in which no interest charges will be due if the marker is paid on time. In other cases, the casino may charge a fee for issuing the marker and/or may not provide a grace period for interest on repayment. Some casinos also offer discounts on losses.

In order to exercise the line of credit, the customer requests a “marker” (step 16) from a casino employee—typically either at a gaming table or at the casino cage. If the marker request is approved, the customer signs the marker and is issued chips (or whatever gaming media is used at the casino in question) in the amount of the marker (step 18).

A marker is a negotiable instrument which authorizes the casino to withdraw funds from the financial account(s) of the customer based on the terms of the credit application. In most cases, the casino (or its agent) will not collect on the marker immediately. The time period between the issuance of the marker and collection of the marker on the customer's account(s) (step 20) is also based upon the terms of the credit application.

Two primary reasons for the popularity of markers with casino customers are (1) that the customer is not required to carry cash or credit cards to the casino floor and (2) that a marker allows the customer to receive gaming media without having the value of the gaming media immediately withdrawn from his or her financial account. As stated above, in some cases, the marker effectively serves as a short-term interest free loan to the customer.

Taking a marker is relatively convenient for customers playing at gaming tables, where casino employees who are authorized to issue markers are readily available. It is much less convenient for a customer to take a marker when playing slot machines, video poker, automated gaming tables, or other gaming equipment that does not involve a live dealer (hereinafter “unattended gaming machines”). In these cases, the customer must leave the unattended gaming machines and go to the casino cage to take the marker. Therefore, there is a need to provide a more convenient option for customers playing unattended gaming machines to take markers.

### SUMMARY

In one embodiment, the present invention is a computer system for performing marker transactions at a casino or other gaming establishment. The computer system comprises (i) a marker account database configured to store information about one or more customers and one or more corresponding markers (ii) and a marker account system configured to maintain the marker account database. The computer system is configured to (1) receive a request, from a customer, for a marker and for funds corresponding to the marker and (2) determine to grant the request by issuing the marker to the customer, wherein the gaming establishment assumes no risk when issuing the marker to the customer. The computer system is configured to (a) update the marker account database based on the marker issued to the customer and (b) provide, to the customer, gaming scrips (or other non-cash gaming instruments) as the requested funds, wherein (i) the gaming scrips having no intrinsic value and (ii) the gaming establishment assumes no risk when providing the gaming scrips to the customer. The computer system is configured to enable the customer to gamble at the gaming establishment using the gaming scrips.

### BRIEF DESCRIPTION OF THE DRAWINGS

The present invention will hereinafter be described in conjunction with the appended drawing figures wherein like numerals denote like elements.

FIG. 1 is a flow diagram showing the basic steps of issuing a marker;

FIG. 2 is a system diagram showing the primary elements of one possible embodiment of the present invention;

FIG. 3 is a diagram showing the primary elements of the kiosk of FIG. 2;

FIG. 4 is a flow diagram showing an example of how a customer would obtain a marker via the kiosk;

FIG. 5 is a flow diagram of processing associated with conventional marker transactions at a gaming establishment; and

FIG. 6 is a flow diagram of processing associated with marker transactions at a gaming establishment that has a computer system that supports the operations of the gaming establishment, according to one embodiment of the present invention.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims. Reference numerals that are introduced in the specification in association with a drawing figure may be repeated in one or more subsequent figures without additional description in the specification in order to provide context for other features.

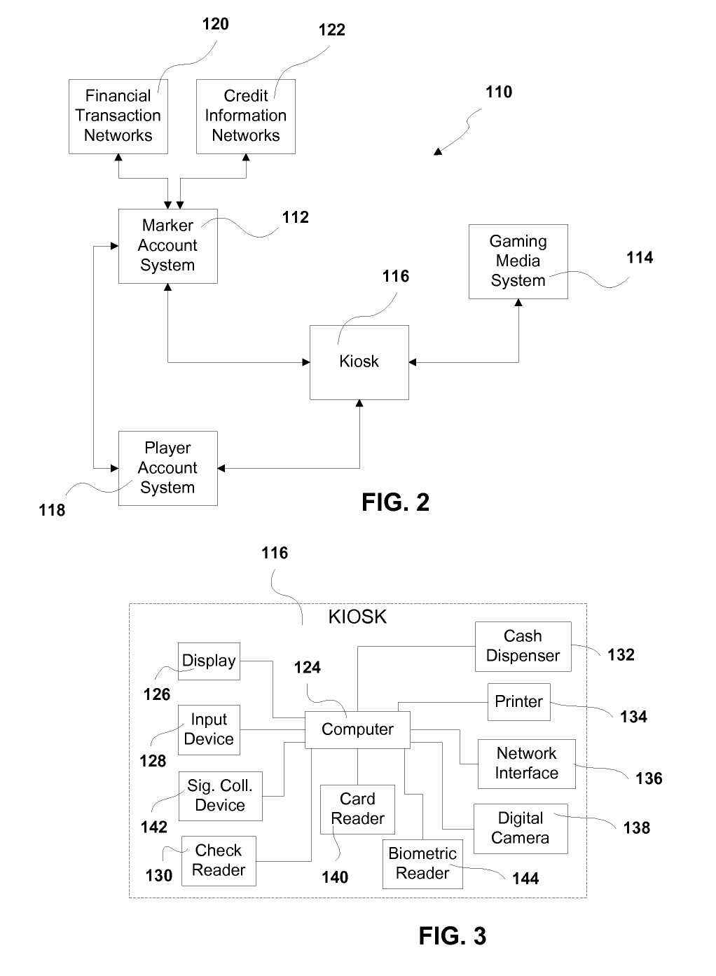

Referring to FIGS. 2 and 3, one possible embodiment of one possible embodiment of the present invention enables a customer to request a marker and be issued the marker funds through an unattended kiosk 116. Enabling a customer to process a marker transaction at a kiosk 116 provides several advantages over traditional marker transactions. One advantage is that customers playing unattended gaming machines can process the marker transaction without having to leave the gaming area, provided that a kiosk 116 is located in the gaming area. In addition, eliminating the need to have a casino representative handle the transaction reduces the overhead associated with each marker transaction. Automating marker transactions also enables the transactions to be handled by a third party (i.e., other than the casino itself), which may be appealing to casinos from both a risk-management and regulatory-compliance perspective.

In order to process marker requests, the kiosk 116 is preferably adapted to communicate with a marker account system 112, a gaming media system 114, and a player account system 118. The marker account system 112 includes a marker account database containing information relating to customers who have established lines of credit through the marker account system 112 and controls and records marker transactions. The customer information contained in the marker account database may include the following categories of data: (1) customer identification data, (2) financial data, and (3) credit term data.

The customer identification data is primarily used to identify the customer associated with the account and to enable positive identification of the customer when a marker is requested. Examples of customer identification data include name, address, social security number, date of birth, and a password. The financial data is primarily used to identify financial accounts held by the customer, and may include current balance (for bank accounts) and/or available credit information (for credit accounts). Information concerning such accounts may be provided by the customer during the application process and/or through the credit history check run by the casino or its agent during evaluation of the customer's credit application.

The credit term data will typically include the terms on which a marker will be issued to the customer. Such terms may include a fee for taking the marker (or an indication that no fee is to be charged), a grace period in which no interest will be charged if the marker is paid in full, and the interest rate and/or fee to be charged if the marker is not paid in full within the grace period.

The marker account database is maintained by the marker account system to track the current status of each marker, wherein each customer may have one or more different markers represented in the database. The status of a marker might identify the original value of the marker and any remaining value of the marker for a marker that has not yet been fully paid off. Note that, when a marker has been partially or fully paid off or sold to a third party, the marker account system updates the marker account database accordingly.

The marker account system 112 is preferably adapted to interface with credit information networks 122, which are used to evaluate customer credit decisions, and financial transaction networks 120 to collect on issued markers. In this embodiment, the marker account system 112 is centralized and contains customer account information for customers of all of the casinos who use the services associated with the marker account system 112. This enables a customer to request a mark at any casino that uses the marker account system 112. In addition, it allows the marker account system 112 to track a customer's credit-related transactions at multiple casinos.

The gaming media system 114 controls and records transactions in which gaming media are issued, cashed, or used in gaming machines. As will be explained in greater detail herein, the kiosk 116 preferably interfaces with the gaming media system 114 so that a payout on a marker can be issued by the kiosk 116 in the form of gaming media. As used in this application, the term “gaming media” refers to any media having monetary value in a casino for game play, such as chips, tokens, vouchers, and the like.

The player account system 118 (also called player reward or player's club accounts) is used to track a customer's activities at a casino (gambling, purchases, etc.) and to provide incentives and/or rewards to customers for their casino-related activities. In the context of the present invention, the kiosk 116 preferably interfaces with the player account system 118 for the purpose of offering incentives to customers during marker transactions, as will be described in greater detail herein. Player account systems are typically operated by an individual casino or by an individual company that owns several casinos.

In order to facilitate the steps of a marker transaction, the kiosk 116 preferably includes a computer 124, a display 126 (optionally, a touch-screen display), an input device 128 (such as a keyboard, soft keys, and/or a numeric keypad), a cash dispenser 132, a printer 134 (preferably capable of printing receipts and gaming vouchers), a network interface 136 (for communicating with the systems identified in FIG. 2), a digital camera 138 or video camera (for recording an image of the customer), a card reader 140 (capable of reading magnetic strips, RFID, and/or other financial card, ID, and/or player card data storage methods), and a signature collection device 142. The kiosk 116 could also optionally include one or more biometric reading devices 144 (e.g., a finger print reader, facial recognition device, etc.), an RFID tag reader (not shown), a check reader 130, and/or a device (not shown) that reads customer identification stored in his or her mobile telephone (such as the information stored in a SIM card). The kiosk 116 may include other components which are used with other kiosk 116 functions.

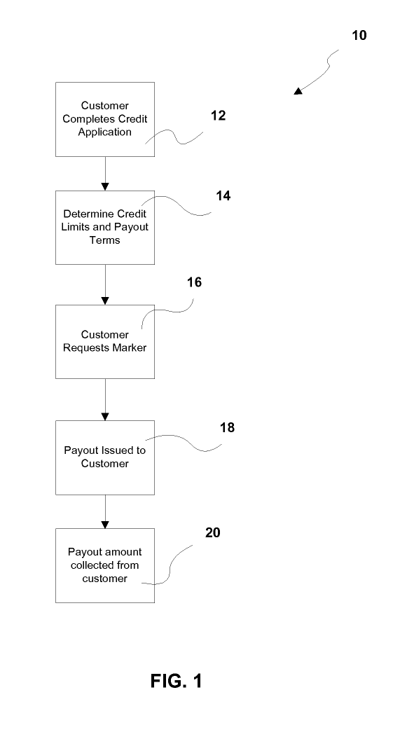

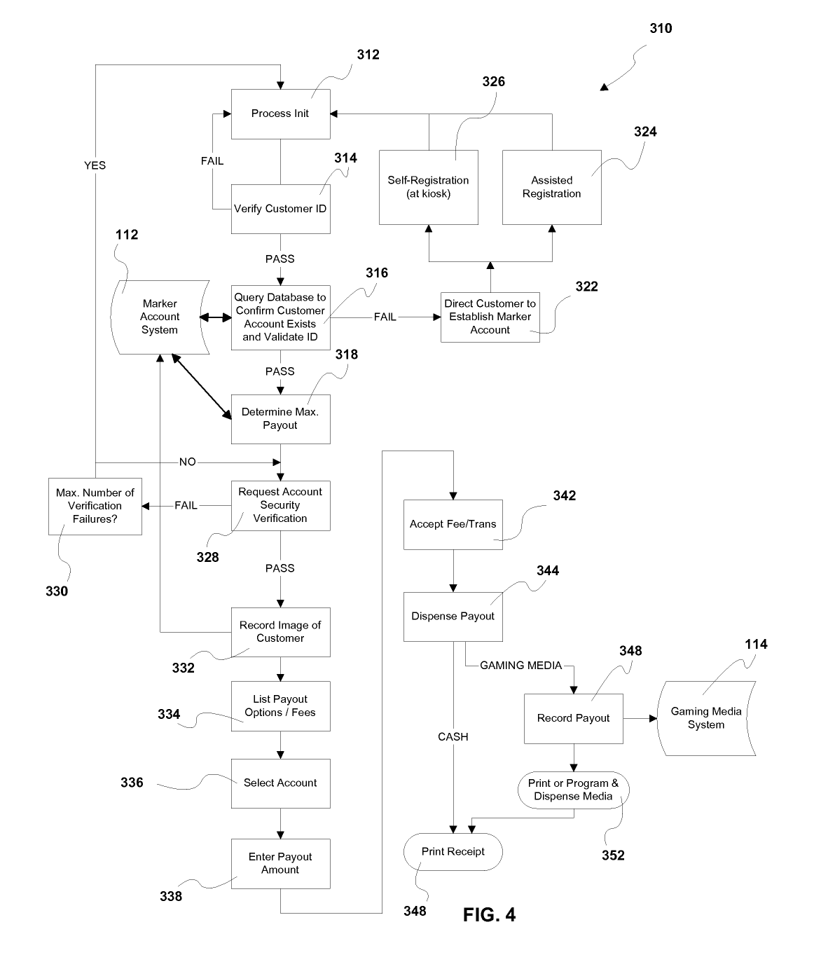

At noted above, the basic steps involved in a traditional marker transaction are outlined in FIG. 1. FIG. 4 shows an example of an improved marker transaction 310 in which a customer requests a marker and is issued a marker payout via the kiosk 116. Throughout the description of the marker transaction 310, components in FIGS. 2 and 3 will be referred to without specific references to FIGS. 2 and 3. The marker transaction 310 is initialized (step 312) by the customer selecting “marker transaction” from a menu of options displayed on the display 126 of the kiosk 116. Optionally, the customer could be offered a marker transaction 310 upon failure of another financial transaction, such as, for example, insufficient funds to process a debit transaction or an incorrect PIN number for a credit card cash advance transaction.

The customer is then presented with a request to verify the customer's identity (step 314). The type of verification required could include swiping an identification card (e.g., a driver's license, player account card, or credit card) through the card reader 140, entering a password, providing an answer to a security question (a pin number, zip code, etc.), and/or biometric data. Obviously, as technology advances and the types of identification required to process financial transactions change, other types of verification could be requested.

If the customer does not provide the requested verification information, the customer is returned to a main menu. If the customer enters the requested verification information, the kiosk 116 then communicates with the marker account system 112 (see FIG. 3) to determine if the customer has a marker account and if the verification information provided by the customer in step 314 matches the information stored in the customer's marker account.

If the customer does not have an existing marker account, the customer is advised of this fact and is directed to establish a marker account (step 322). The customer may then proceed to the casino cage to establish a marker account (step 324). Optionally, the kiosk 116 may be configured to enable the customer to establish a marker account (and therefore, a line of credit) at the kiosk 116 (step 326).

If the customer does have an existing marker account, account-specific information relating to the marker transaction 310 is transmitted to the kiosk 116. Such information could include the accounts on which the marker can be drawn, the maximum marker amount (step 318) that can be issued to the customer, and the marker terms (e.g., grace period and fees).

The customer is then required to provide security verification information for the marker account (step 328). Typically, the security verification information is data that is provided when the customer applied for the marker account. If the information entered by the customer does not match the security verification information stored in the marker account system 112, the customer is allowed to re-enter the security verification information a pre-determined maximum number of times (see step 330). If the pre-determined number of attempts is reached, the customer is returned to the main menu.

If the information entered by the customer matches the security verification information stored in the marker account system 112, a digital image of the customer may be taken (step 332) by the digital camera 138 and recorded to the marker account system 112, in order to further confirm the identity of the person executing the marker transaction 310.

The customer is then presented with a list of options (step 334) for payout of the marker, along with the terms and any fees associated with each option. For example, option 1 is for a marker drawn on the customer's checking account in which no fee is charged and there is a 30-day grace period for repayment and option 2 is for a marker drawn on the customer's credit card in which a 5% fee is charged on the marker amount and the grace period is 5 days. The customer then selects (step 336) one of the options provided in step 334 and selects the amount of the marker and form of payout (338). Optionally, the customer may be provided with the option to split the payout between two different forms (e.g., part is cash and part in gaming media).

As an alternative to steps 334 and 336, as described above, the customer could select an order of preference for payout options as part of the marker account application process, in which case in step 334, the customer would be presented with the payout option that is highest in the customer's order or preference.

There are several optional features that could be incorporated into the presentation of options (step 334) to the customer. For example, the customer's attention could be directed to the “preferred” transaction option, which includes the lowest fee or provides for the highest maximum payout amount. In addition, the customer could be offered incentives, such as bonus gaming media, instant cash back, a raffle entry, etc., associated with a specific option and/or a specific form of payout. For example, the customer could be offered an incentive to dispense the payout entirely in gaming media. In the event that the customer refuses all of the options presented in step 334, the customer could optionally be provided with an additional option with a lower fee than the options presented in step 334.

The customer is then directed to expressly confirm his or her acceptance of the transaction 310 and its terms (step 342). Acceptance could be in any form that is acceptable under industry standards and applicable regulations. For example, a digital signature could be entered via the signature collection device 142. The transaction is then accepted by the kiosk 116, and the marker payout is dispensed to the customer (step 344).

If all or a portion of the payout is to be dispensed as gaming media, the gaming media is programmed (in the case of an RFID token, for example) or printed (in the case of a bar-code based voucher) (step 352), and information concerning the gaming media is recorded and transmitted to the gaming media system 114 (step 348).

The kiosk 116 is also preferably configured to enable customers to pay off outstaying markers, or make a payment toward outstanding markers via the kiosk 116 and using any form of payment that the kiosk 116 is capable of processing. In particular, it is preferable that the kiosk 116 be adapted to accept payment via gaming media, in which case the kiosk 116 would include the component(s) and software programming necessary to determine the value of the type(s) of gaming media used at the casino in which the kiosk 116 is located, as well as to deactivate and/or capture gaming media being redeemed. In the case of bar code vouchers, the kiosk 116 would include a bar code reader. In the case of gaming chips or tokens with embedded RDIF chips, the kiosk 116 would have an RFID reader.

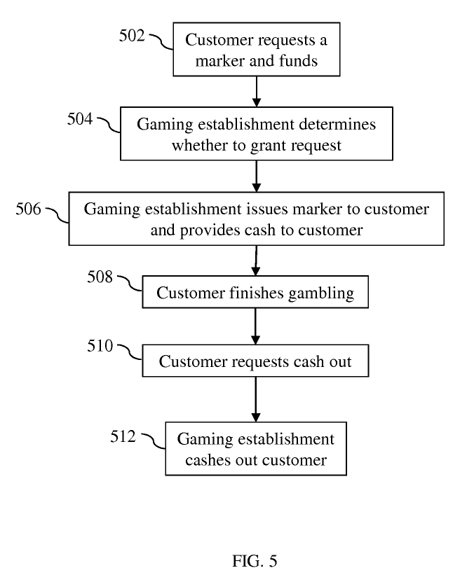

FIG. 5 is a flow diagram of processing associated with conventional marker transactions at a gaming establishment. Processing of the conventional marker transactions begins with a customer requesting a marker and funds corresponding to the requested marker, at a cage in the gaming establishment (step 502).

The gaming establishment determines whether or not to grant the request (step 504) using conventional techniques described previously. If the decision is not to grant the request, then the customer is informed that his/her request has been denied. If, however, the decision is to grant the request, then the gaming establishment issues a marker to the customer and provides cash (or other valued form of tender) to the customer based on the value of the marker (step 506). Note that, in general, the face value of the marker may be different from the amount of cash provided to the customer.

At the moment that the gaming establishment provides cash to the customer, the gaming establishment assumes risk for having issued the marker to the customer, because the gaming establishment has provided the customer with something (i.e., cash) that has value, for example, outside of the gaming establishment. After receiving that cash, the customer is free to gamble in the gaming establishment using that cash. On the other hand, the customer is also free to leave the gaming establishment with the cash without using any of it for gambling. Furthermore, the customer is at risk of having that cash stolen.

The risk assumed by the gaming establishment is associated with the effort to get the customer to pay off the marker. Depending on the gaming establishment, that risk may be retained by the gaming establishment itself or the marker may be sold by the gaming establishment to a third party, who will then assume the risk associated with getting the customer to pay off the marker. Note that, in general, the sale price for the marker to a third party may be different from the original face value of the marker to the gaming establishment.

Initially, the magnitude of the risk is based on the amount of cash provided by the gaming establishment to the customer. If the marker is sold to a third party, then the magnitude of the risk assumed by the third party is based on the sale price paid by the third party to the gaming establishment for the marker. In any case, the magnitude of the risk is independent of whether or not the customer uses the provided cash to gamble at the gaming establishment and independent of whether the customer wins or loses when he/she does use the provided cash to gamble at the gaming establishment.

If and when the customer completes gambling using the previously provided cash (step 508), the customer will either have no gaming funds left or will have some non-zero gaming funds (e.g., chips, credit on a player card) that may be less than, equal to, or greater than the value of the previously provided cash. If the customer has no gaming funds left, then the holder of the marker (i.e., either the gaming establishment or the third-party purchaser of the marker) will be left with the onus of having to collect on the marker. If the customer has some non-zero gaming funds remaining, then the customer will attempt to cash out at a cage of the gaming establishment (step 510). Depending on the particular gaming establishment, the gaming establishment may allow the user to cash out the total value of his/her remaining gaming funds (step 512) without requiring the customer to pay off the marker at that time, because the gaming establishment previously analyzed the customer's credit status and decided to assume the risk of issuing the marker to the customer at the time that the marker was originally issued to the customer.

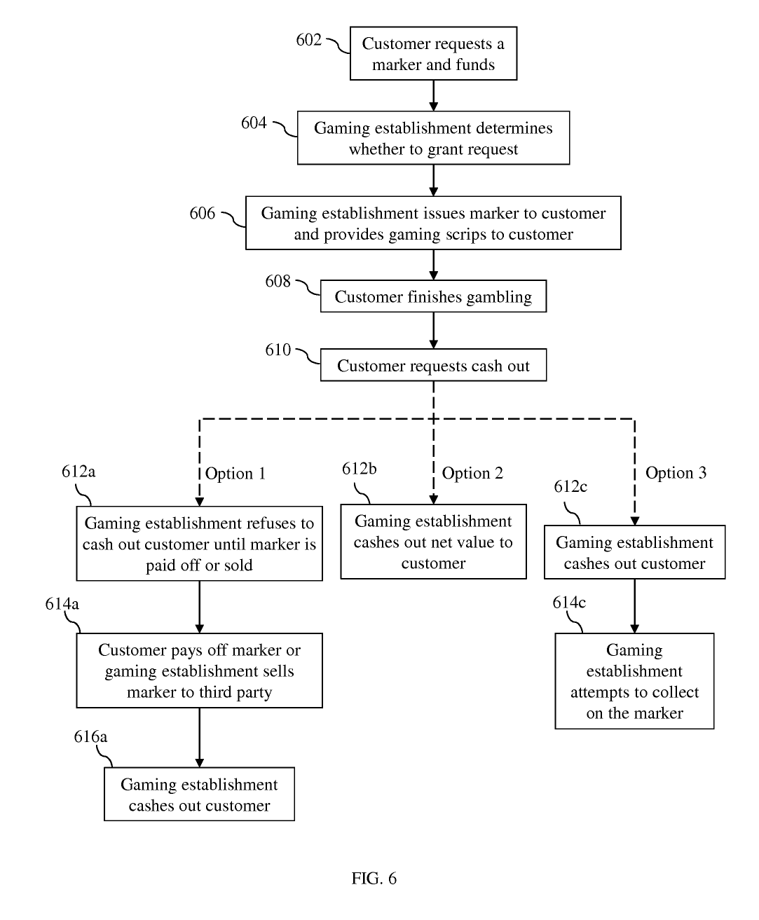

FIG. 6 is a flow diagram of processing associated with marker transactions at a gaming establishment that has a computer system that supports the operations of the gaming establishment, according to one embodiment of the present invention. Depending on the particular gaming establishment, the computer system may be more or less sophisticated in supporting those operations. In one example, the computer system may be based on the technology depicted and described in the context of FIGS. 1-4. As another example, the computer system may be based on the technology depicted and described in the context of the parent PCT application.

Processing of exemplary inventive marker transactions begins with a customer requesting a marker and gaming funds corresponding to the requested marker (step 602). This request may be made, for example, by the customer using a kiosk, such as kiosk 116 of FIGS. 2 and 3, that is part of the gaming establishment's computer system, or by the customer at a cage in the gaming establishment. In the latter case, the employee of the gaming establishment at the cage processes the request using a computer terminal that is part of the gaming establishment's computer system.

The computer system determines whether or not to grant the request (step 604). In this case, since, as described further below, the risk to the gaming establishment is at most a deferred risk and possibly little or no risk at all, the gaming establishment may be more willing to grant the customer's original request for a marker and/or may be willing to grant markers with greater value than would be the case under the conventional marker transactions of FIG. 5.

If the decision is not to grant the request, then the customer is informed that his/her request has been denied. If, however, the decision is to grant the request, then the gaming establishment issues a marker to the customer and provides not cash, but gaming scrips to the customer based on the value of the marker (step 606). In one embodiment, the gaming scrips are based on the technology described in the parent PCT application, wherein the individual gaming scrips are uniquely identified and assigned to the particular customer in a gaming scrip database maintained by the computer system. Here, too, the face value of the gaming scrips may be different from the value of the marker. For example, a customer may request a marker for $100, but choose to receive only $40 in gaming scrips for a particular gambling session. Such a customer might be allowed to receive another $60 in gaming scrips at some later time based on that same marker.

Although the exemplary embodiment depicted in FIG. 6 is described in the context of gaming scrips, the present invention can additionally or alternatively be implemented in the context of other types of non-cash gaming instruments, such as (without limitation) chips, credits, and/or player accounts.

At the moment that the gaming establishment provides gaming scrips to the customer, the gaming establishment assumes no risk for having issued the marker to the customer or for having provided the gaming scrips to the customer, because the gaming establishment has provided the customer with something (i.e., the gaming scrips) having no intrinsic value outside of the gaming establishment. In certain embodiments, the gaming scrips can be used only for gambling at the gaming establishment, and in particular embodiments, only by the particular customer to whom the uniquely identified gaming scrips were issued. As such, because the gaming scrips have no intrinsic value outside of the gaming establishment, the customer is effectively forced (albeit not absolutely required) to use the gaming scrips to gamble at the gaming establishment.

If the customer uses the gaming scrips to gamble and loses all of the face value of the gaming scrips (or if the customer fails to use some or all of the gaming scrips to gamble), then the gaming establishment will still have not assumed any risk in having previously issued the marker to the customer. If the customer never attempts to cash out (because, for example, the customer gambled and lost all of his gaming scrips or never even gambled at all), then the gaming establishment can still attempt to make the customer pay off the marker. Significantly, however, in this case, the gaming establishment will never assume any risk associated with the issuance of the marker to the customer, because, even if the gaming establishment fails to collect any money from the customer for the marker, the gaming establishment never provided anything of intrinsic value to the customer.

If the customer does use the gaming scrips to gamble and has some non-zero gaming funds remaining after he/she has completed his/her gambling (step 608) and has requested to be cashed out (step 610), then, at the time that the gaming establishment cashes out the customer, the gaming establishment might, for the first time, assume any risk for having previously issued the marker to the customer. Significantly, the magnitude of that risk will be the lesser of (i) the customer's remaining non-zero gaming funds and (ii) the total face value of the originally provided gaming scrips. In particular, if the customer's remaining gaming funds are less than the face value of the originally provided gaming scrips, then the only risk to the gaming establishment is the value of those remaining gaming funds, because that is the amount of money that the gaming establishment would lose if it were unsuccessful in getting the customer to pay off the marker. If, however, the customer's remaining gaming funds are greater than or equal to the face value of the originally provided gaming scrips, then the risk to the gaming establishment is equal to the face value of the originally provided gaming scrips, because that is the value that the gaming establishment originally provided to the customer. For example, assume that a customer requests a $200 marker but chooses to receive only $100 in gaming scrips on that $200 marker. In a first possible scenario, the customer uses the $100 in gaming scrips to gamble and ends up with $50 in remaining gaming funds (e.g., chips). If the gaming establishment allows the customer to cash out his/her $50 in remaining gaming funds without first paying off the marker, then, at that moment, the gaming establishment will, for the first time, assume any risk for having previously issued the marker to the customer. In this first scenario, the magnitude of this deferred risk assumed by the gaming establishment will be $50, not the $200 value of the marker and not the $100 in gaming scrips originally provided to the customer.

In a second possible scenario, the customer uses the $100 in originally provided gaming scrips and ends up with $150 in remaining gaming funds. Again, if the gaming establishment allows the customer to cash out his/her $150 in remaining gaming funds without first paying off the marker, then, at that moment, the gaming establishment will, for the first time, assume any risk for having previously issued the marker to the customer. In this second scenario, the magnitude of this deferred risk assumed by the gaming establishment will be the $100 in gaming scrips originally provided to the customer, not the $200 value of the marker and not the $150 in remaining gaming funds.

Note that the customer's remaining gaming funds could include some of the originally provided gaming scrips. Nevertheless, depending on the particular gaming establishment, the gaming establishment might not allow the customer to cash out any of the originally provided gaming scrips.

Note that when a customer cashes out, the customer receives cash or other negotiable funds, such as (without limitation) credit applied to the customer's credit card.

A gaming establishment has a number of different options for cashing out a customer having remaining gaming funds. According to one option, the gaming establishment can force the customer to pay off the marker or the gaming establishment can sell the marker to a third party before cashing out the customer's remaining gaming funds. If the customer refuses to or cannot otherwise pay off the marker and if the marker is not sold to a third party, then the gaming establishment can simply refuse to cash out the customer's remaining gaming funds until the marker is paid off (step 612a). If and when the marker is paid off or sold (step 614a), then the gaming establishment cashes out the customer based on the full amount of his/her remaining gaming funds (step 616a). In this case, the gaming establishment never assumes any risk in having issued the marker to the customer, because the gaming establishment never provided anything to the customer having intrinsic value. When the marker is (partially or fully) paid off or sold to a third party, the computer system updates the marker account database to reflect the new status of the marker.

Alternatively, if the customer's remaining gaming funds are greater than or equal to the face value of the originally provided gaming scrips, then the gaming establishment can choose to cash out only the net value (i.e., the customer's remaining funds minus the face value of the originally provided gaming scrips) to the customer (step 612b). Here, too, the gaming establishment never assumes any risk in having issued the marker to the customer, because again the gaming establishment never provided anything to the customer having intrinsic value.

As another possible scenario, the gaming establishment cashes out the full amount of remaining gaming funds to the customer (step 612c) and subsequently attempts to collect on the marker (step (614c). In this case, the risk assumed by the gaming establishment is limited to the lesser of (i) the customer's remaining gaming funds and (ii) the total face value of the originally provided gaming scrips.

Depending on the gaming establishment, a customer may cash out at a kiosk or at a cage.

While the principles of the invention have been described above in connection with preferred embodiments, it is to be clearly understood that this description is made only by way of example and not as a limitation of the scope of the invention.

The present invention may be implemented as (analog, digital, or a hybrid of both analog and digital) circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, general-purpose computer, or other processor.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. The present invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A computer system-implemented method for performing marker transactions at a gaming establishment, the method comprising:
(a) the computer system receiving a request, from a customer, for a marker and for funds corresponding to the marker;
(b) the computer system determining to grant the request by issuing the marker to the customer, wherein the gaming establishment assumes no risk when issuing the marker to the customer;
(c) the computer system updating a marker account database in the computer system based on the marker issued to the customer;
(d) the computer system providing, to the customer, one or more non-cash gaming instruments as the requested funds, wherein:
the one or more non-cash gaming instruments have no intrinsic value; and
the gaming establishment assumes no risk when providing the one or more non-cash gaming instruments to the customer; and
(e) the computer system enabling the customer to gamble at the gaming establishment using the one or more non-cash gaming instruments.

2. The invention of claim 1, wherein:
the gaming establishment requires the customer to pay off the marker prior to cashing out the customer;
the computer system updates the marker account database based on the customer paying off the marker; and
the gaming establishment never assumes any risk for issuing the marker to the customer.

3. The invention of claim 1, wherein:
the gaming establishment sells the marker to a third party prior to cashing out the customer;
the computer system updates the marker account database based on the sale of the marker to the third party; and
the gaming establishment never assumes any risk for issuing the marker to the customer.

4. The invention of claim 1, wherein, when the customer terminates gambling with some remaining gaming funds greater than or equal to the value of the marker:
the gaming establishment cashes out the customer by providing, to the customer, a net value equal to a difference between the remaining gaming funds and a total face value of the one or more gaming instruments;
the computer system updates the marker account database based on the cashing out of the customer; and
the gaming establishment never assumes any risk for issuing the marker to the customer.

5. The invention of claim 1, wherein, when the gaming establishment cashes out the customer by providing negotiable funds to the customer:
the computer system updates the marker account database based on the cashing out of the customer;
the gaming establishment first assumes any risk for issuing the marker when the gaming establishment provides the negotiable funds to the customer; and
the magnitude of the risk is equal to the lesser of (i) the negotiable funds and (ii) a total face value of the one or more non-cash gaming instruments.

6. The invention of claim 1, wherein, if the customer never uses the one or more non-cash gaming instruments to gamble at the gaming establishment, then the gaming establishment never assumes any risk for having issued the marker to the customer.

7. The invention of claim 1, wherein, if the customer never cashes out, then the gaming establishment never assumes any risk for having issued the marker to the customer.

8. The invention of claim 1, wherein the gaming establishment refuses to cash out any non-cash gaming instruments for the customer.

9. The invention of claim 1, wherein the computer system assigns the one or more non-cash gaming instruments only to the customer.

10. The invention of claim 1, wherein the computer system allows only the customer to use the one or more non-cash gaming instruments for gambling at the gaming establishment.

11. The invention of claim 1, further comprising the gaming establishment attempting to have the customer pay off the marker, wherein, if the customer never cashes out, then the gaming establishment never assumes any risk for issuing the marker to the customer, even if the gaming establishment fails to get the customer to pay off the marker.

12. A non-transitory machine-readable storage medium, having encoded thereon program code, wherein, when the program code is executed by a computer system, the computer system implements a method for performing marker transactions at a gaming establishment, the method comprising:
(a) the computer system receiving a request, from a customer, for a marker and for funds corresponding to the marker;
(b) the computer system determining to grant the request by issuing the marker to the customer, wherein the gaming establishment assumes no risk when issuing the marker to the customer;
(c) the computer system updating a marker account database in the computer system based on the marker issued to the customer;
(d) the computer system providing, to the customer, one or more non-cash gaming instruments as the requested funds, wherein:
the one or more non-cash gaming instruments have no intrinsic value; and
the gaming establishment assumes no risk when providing the one or more non-cash gaming instruments to the customer; and
(e) the computer system enabling the customer to gamble at the gaming establishment using the one or more non-cash gaming instruments.

13. A computer system for performing marker transactions at a gaming establishment, the computer system comprising:
a marker account database configured to store information about one or more customers and one or more corresponding markers; and
a marker account system configured to maintain the marker account database, wherein:
(a) the computer system is configured to receive a request, from a customer, for a marker and for funds corresponding to the marker;
(b) the computer system is configured to determine to grant the request by issuing the marker to the customer, wherein the gaming establishment assumes no risk when issuing the marker to the customer;
(c) the computer system is configured to update a marker account database in the computer system based on the marker issued to the customer;
(d) the computer system is configured to provide, to the customer, one or more non-cash gaming instruments as the requested funds, wherein:
the one or more non-cash gaming instruments have no intrinsic value; and
the gaming establishment assumes no risk when providing the one or more non-cash gaming instruments to the customer; and
(e) the computer system is configured to enable the customer to gamble at the gaming establishment using the one or more non-cash gaming instruments.

14. The invention of claim 13, wherein the computer system further comprises a kiosk configured to communicate with the marker account system, wherein:
the kiosk is configured to receive, from the customer, the request for the marker and for the corresponding funds;
the marker account system is configured to determine to grant the request by issuing the marker to the customer;
the marker account system is configured to update the marker account database based on the marker issued to the customer; and
the kiosk is configured to provide, to the customer, the one or more non-cash gaming instruments.

15. The invention of claim 14, wherein the kiosk is configured to enable the customer to cash out after gambling at the gaming establishment.

16. The invention of claim 13, wherein the computer system is configured to assign the one or more non-cash gaming instruments only to the customer.

17. The invention of claim 13, wherein the computer system is configured to allow only the customer to use the one or more non-cash gaming instruments for gambling at the gaming establishment.
